(19) United States
(12) Patent Application Publication
(10) Pub. No.: US 2013/0137467 A1
(43) Pub. Date: May 30, 2013

(54) MOBILE DEVICE AND METHOD FOR DETERMINING LOCATION OF MOBILE DEVICE

(71) Applicants: YEN-TING KUO, Tu-Cheng (TW); KE WAN, Chengdu City (CN); HSIAO-FENG YANG, Tu-Cheng (TW)

(72) Inventors: YEN-TING KUO, Tu-Cheng (TW); KE WAN, Chengdu City (CN); HSIAO-FENG YANG, Tu-Cheng (TW)

(21) Appl. No.: 13/631,890

(22) Filed: Sep. 29, 2012

(30) Foreign Application Priority Data
Nov. 30, 2011 (CN) 201110389729.9

(51) Int. Cl. H04W 24/00

(52) U.S. Cl. 455/457

(57) ABSTRACT

A method for determining a location of a mobile device, an address signal is received from a signal generator. The method transforms the address signal into a frequency domain signal, determines a maximum energy value of the frequency domain signal, determines a virtual address according to a frequency value corresponding to the maximum energy value, and sends the virtual address to a server. The method further receives location information of the mobile device corresponding to the virtual address from the server, and displays the location information on a display device of the mobile device.

### BACKGROUND

1. Technical Field

Embodiments of the present disclosure relate to positioning technology, and particularly to a mobile device and method for determining a location of the mobile device.

2. Description of Related Art

Mobile devices (e.g., smart phones) may be equipped with a global positioning system (GPS) chip, so that location-based service (LBS) providers can determine locations of the mobile devices by analyzing GPS information sent from the mobile devices, and returning the determined locations to the mobile devices. However, if a mobile device is not equipped with the GPS chip, the mobile device cannot obtain location information from the LBS providers. Additionally, location information may not be obtained where the mobile device is inside a building due to interference. Therefore, an efficient method for determining the location of the mobile device is desired.

### BRIEF DESCRIPTION OF THE DRAWINGS

FIG. 1 is a schematic diagram of one embodiment of a mobile device connected to a signal generator and a server.

FIG. 2 is a schematic diagram of one embodiment of the mobile device including a positioning system.

FIG. 3 is a schematic diagram of function modules of the positioning system included in the mobile device.

FIG. 4 is a flowchart of one embodiment of a method for determining a location of the mobile device.

FIG. 5 is a schematic diagram of an example of a frequency domain signal.

FIG. 6 is a schematic diagram of an example of a mapping document.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

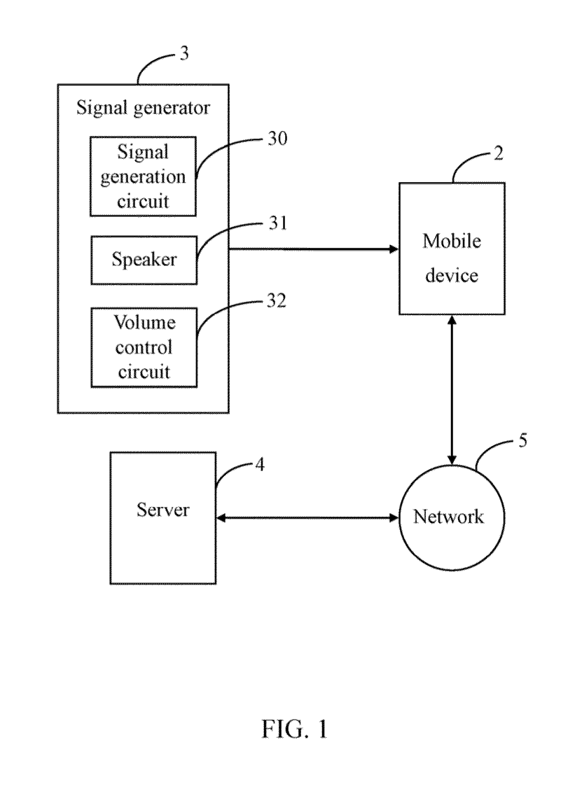

FIG. 1 is a schematic diagram of one embodiment of a mobile device 2 connected to a signal generator 3 and a server 4. The mobile device 2 is connected to the signal generator 3 through a wireless network (e.g., WIFI), and connected to the server 4 through a network 5, such as the Internet, an intranet or other suitable communication network. The mobile device 2 may be a smart phone or a personal digital assistant (PDA).

In one embodiment, the signal generator 3 may include, but is not limited to, a signal generation circuit 30, a speaker 31, and a volume control circuit 32. The signal generation circuit 30 is located in a specified position (e.g., an interior room), and is used to obtain an address signal (e.g., a sine wave signal) of the signal generator 3. Then, the signal generator 3 emits the address signal through the speaker 31, so that the mobile device 2 may receive the address signal when the mobile device 2 is located near the signal generator 3. The volume control circuit 32 is used to adjust a volume level (i.e., an amplitude) of the speaker 31, so as to adjust a transmission distance of the address signal. The signal generator 3 may be equipped with a WIFI hotspot which is located in a public space.

In one embodiment, a frequency of the sine wave signal generated by the signal generation circuit 30 is greater than 18 kHz (i.e., a high frequency signal). A frequency response range of the speaker 31 is [18 kHz, 20 kHz], a total harmonic distortion (THD) of the speaker 31 is less than 0.5%. The high frequency signal cannot be heard by a user of the mobile device 2, so normal communications with other people using the mobile device 2 are not affected.

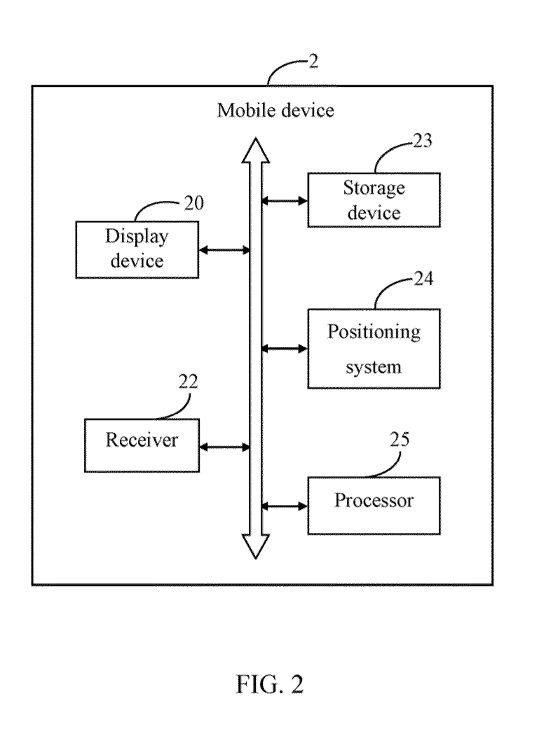

FIG. 2 is a block diagram of one embodiment of the mobile device 2 including a positioning system 24. The mobile device 2 further includes a display device 20, a receiver 22, a storage device 23, and at least one processor 25. It should be understood that FIG. 2 illustrates only one example of the mobile device 2 that may include more or fewer components than illustrated, or have a different configuration of the various components in other embodiments.

The display device 20 may be a liquid crystal display (LCD), a touch sensitive screen or other display device, and the receiver 22 receives the address signal sent from the signal generator 3.

The positioning system 24 is used to determine a virtual address (e.g., 0-0-0-18000) of the mobile device 2 according to the address signal received from the signal generator 3, send the virtual address to the server 4, and receive location information (e.g., a physical address) of the mobile device 2 sent from the server 4. In one embodiment, the positioning system 24 may include computerized instructions in the form of one or more programs that are executed by the at least one processor 25 and stored in the storage device 23 (or memory). A detailed description of the positioning system 24 will be given in the following paragraphs.

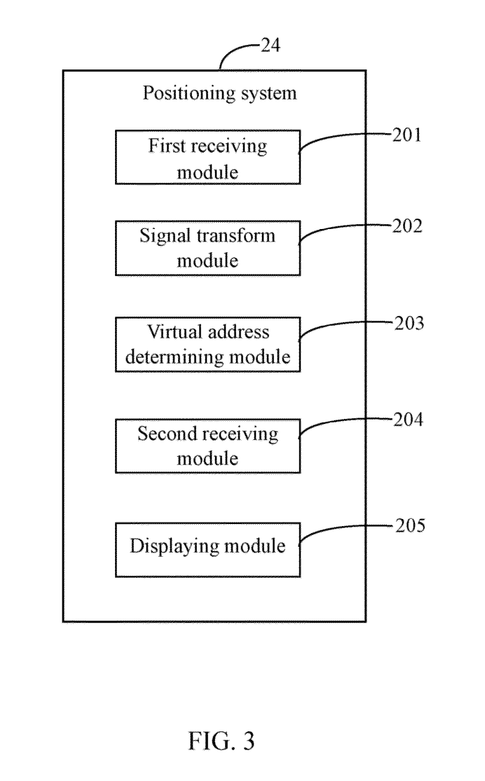

FIG. 3 is a block diagram of function modules of the positioning system 24 included in the mobile device 2. In one embodiment, the positioning system 24 may include one or more modules, for example, a first receiving module 201, a signal transform module 202, a virtual address determining module 203, a second receiving module 204, and a displaying module 205. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

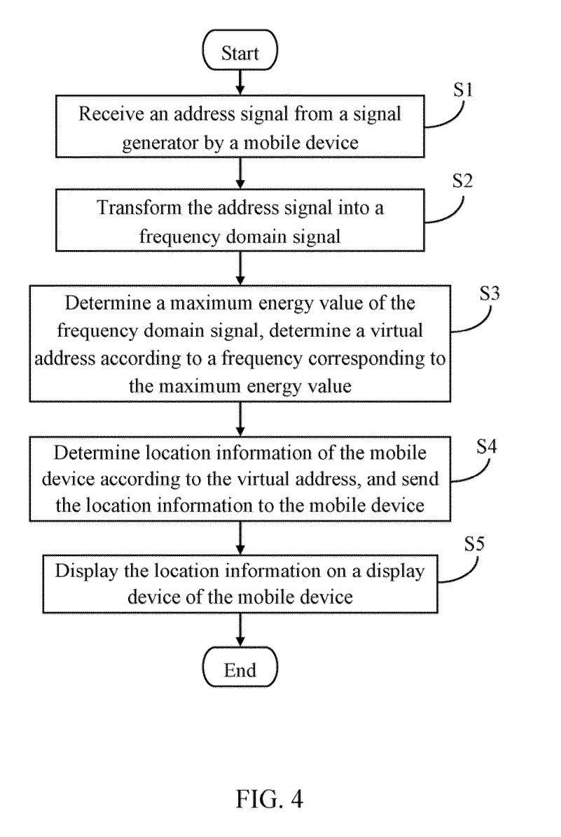

FIG. 4 is a flowchart of one embodiment of a method for determining a location of the mobile device 2. Depending on the embodiment, additional steps may be added, others removed, and the ordering of the steps may be changed.

In step S1, the first receiving module 201 receives an address signal from the signal generator 3. In one embodiment, the signal generator 3 generates a plurality of address signals by generating one or more sine wave signals, and broadcasts one of the address signals at a preset time interval (e.g., five seconds). Three methods for generating the address signals are illustrated as follows.

A first method is called as a single frequency mode. In the single frequency mode, one sine wave signal is generated by the signal generator 3, a sampling frequency of the sine wave signal is 44,100 Hz, a sampling length is 16 bits, and a format of the sine wave signal is a pulse coding modulation (PCM) format. The address signals in the first method are obtained by a first formula (1).

$$Amp \times {\sum }_{i = 0}^{n} sin ( 2 π \times {f}_{0} \times \frac{1}{44100} ) . \qquad ( 1 )$$

In the first formula, “f₀” represents a preset frequency of the address signals (e.g., f₀=18 kHz), “Amp” represents an amplitude of the sine wave signal, and “n” represents a number of cycles of the sine wave signal. If a frequency interval of the address signals is 100 Hz, twenty-one address signals are obtained by applying the first formula.

A second method is called as a complex frequency mode. In the complex frequency mode, a plurality of sine wave signals are generated by the signal generator 3. For example, if eight sine wave signals are generated, a number of the address signals is determined by a second formula (2).

C₁²¹+C₂²¹+C₃²¹+C₄²¹+ . . . +C₈²¹=104446 (2).

If two sine wave signals are used for example, the address signals in the second method are obtained by a third formula (3).

$$Amp \times ( {\sum }_{k = 0}^{m} {\sum }_{i = 0}^{n} sin ( 2 π \times {f}_{k} \times \frac{1}{44100} ) ) . \qquad ( 3 )$$

In the third formula, “fₖ” represents the preset frequency of the address signals (e.g., fₖ=18 kHz), “Amp” represents an amplitude of the two sine wave signals, “m” represents a first number of cycles of a first sine wave signal, and “n” represents a second number of cycles of a second sine wave signal.

A third method is called enhanced mode which is a combination of the complex frequency mode and an additional signal (e.g., a WIFI signal). For example, a format of the enhanced mode include three complex frequency signals and one WIFI signal.

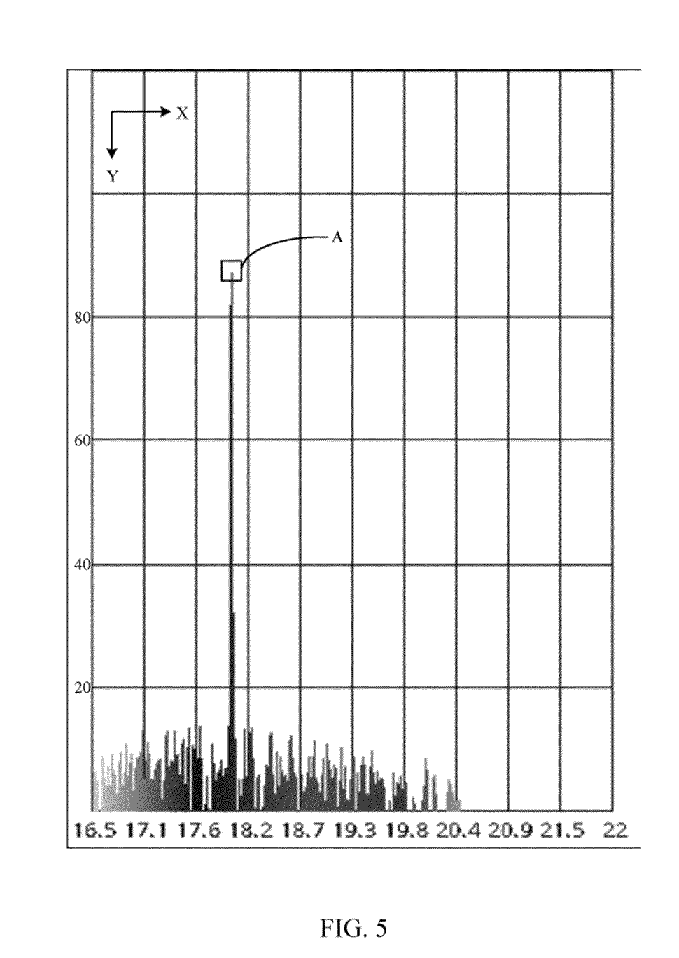

In step S2, the signal transform module 202 transforms the address signal into a frequency domain signal using a fast Fourier transform (FFT) method. An example of the frequency domain signal which is transformed using the FFT method is shown in FIG. 5, where an X-axis represents frequency values (unit is kHz), and a Y-axis represents energy values of the frequency domain signal (unit is dB). In other embodiments, the signal transform module 202 may transform the address signal into the frequency domain signal using other methods, such as a discrete cosine transform (DCT) method.

In step S3, the virtual address determining module 203 determines a maximum energy value of the frequency domain signal, determines a virtual address according to a frequency value corresponding to the maximum energy value (hereinafter referred to as “the frequency of the maximum energy value”), and sends the virtual address to the server 4 through the network 5.

In one embodiment, the virtual address includes the frequency value corresponding to the maximum energy value and other preset frequency values. For example, as shown in FIG. 5, point “A” represents the maximum energy value of the frequency domain signal, the frequency value corresponding to point “A” is 18000 Hz, and thus the virtual address may be 0-0-0-18000. That is to say, the three other preset frequency values are zero. In other embodiments, the virtual address may be 18000-0-0-0.

An example of determining the maximum energy value of the frequency domain signal is as follows. First, the virtual address determining module 203 obtains energy values that are greater than a preset value (e.g., 60 dB) from the frequency domain signal. Second, the virtual address determining module 203 creates a binary search tree using the obtained energy values. Third, the virtual address determining module 203 searches for a maximum value in the binary search tree using a binary tree traversal method, the maximum value is determined as the maximum energy value of the frequency domain signal.

In other embodiments, the signal transform module 202 may transform the address signal into a plurality of frequency domain signals at different times. Then, the address determining module 203 determines a plurality of maximum energy values of the different frequency domain signals, and determines the virtual address according to a plurality of frequency values corresponding to the maximum energy values.

In step S4, the server 4 determines location information (e.g., the physical address) of the mobile device 2 according to the virtual address, and sends the location information to the mobile device 2 through the network 5. In one embodiment, the server 4 determines the location information of the mobile device 2 according to a preset mapping document 40, the preset mapping document 40 stores a one-to-one mapping relation between a plurality of virtual addresses of the mobile device 2 and physical location information of the mobile device 2.

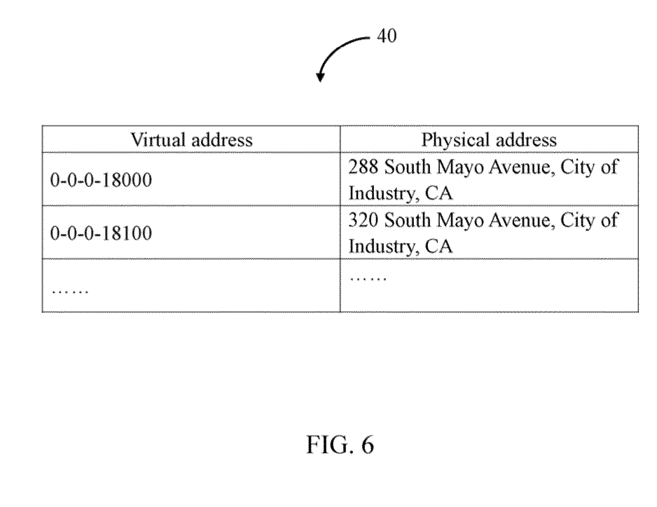

As shown in FIG. 6, a first column of the preset mapping document 40 stores virtual addresses, and a second column of the preset mapping document 40 stores physical addresses corresponding to the virtual addresses. For example, the physical address of the mobile device 2 corresponding to the virtual address “0-0-0-18000” is “288 South Mayo Avenue, City of Industry, CA”.

In step S5, the second receiving module 204 receives the location information of the mobile device 2 from the server 4. Then, the displaying module 205 displays the location information on the display device 20 of the mobile device 2.

In some embodiments, the mobile device 2 obtains the location information according to the address signal generated by the signal generator 3 in one specified position, so that a global positioning system (GPS) chip is not needed. Furthermore, the location information can be determined even when the mobile device 2 is in the middle of large “signal-proof” building so long as the signal generator 3 is also located in the interior of the building.

In other embodiments, the server 4 of FIG. 1 can be removed, thus, step S4 is executed by the mobile device 2 itself.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for determining a location of a mobile device comprising a processor, the method comprising:
receiving an address signal from a signal generator;
transforming the address signal into a frequency domain signal;
determining a maximum energy value of the frequency domain signal, determining a virtual address according to a frequency value corresponding to the maximum energy value, and sending the virtual address to a server;
receiving location information of the mobile device corresponding to the virtual address from the server; and
displaying the location information on a display device of the mobile device.

2. The method according to claim 1, wherein the address signal is obtained according to one or more sine wave signals generated by the signal generator.

3. The method according to claim 2, wherein the address signal is obtained using a single frequency mode, a complex frequency mode, or an enhanced mode.

4. The method according to claim 1, wherein the address signal is transformed into the frequency domain signal using a fast Fourier transform (FFT) method or a discrete cosine transform (DCT) method.

5. The method according to claim 1, wherein the maximum energy value of the frequency domain signal is determined by:
obtaining energy values that are greater than a preset value from the frequency domain signal;
creating a binary search tree using the obtained energy values; and
searching for a maximum value in the binary search tree using a binary tree traversal method, the maximum value being determined as the maximum energy value of the frequency domain signal.

6. The method according to claim 1, wherein the virtual address comprises the frequency value corresponding to the maximum energy value and preset frequency values.

7. The method according to claim 1, wherein the location information of the mobile device is determined according to a preset mapping document, the preset mapping document storing a one-to-one mapping relation between a plurality of virtual addresses of the mobile device and physical location information of the mobile device.

8. A mobile device, comprising:
a storage device;
at least one processor; and
one or more modules that are stored in the storage device and are executed by the at least one processor, the one or more modules comprising:
a first receiving module that receives an address signal from a signal generator;
a signal transform module that transforms the address signal into a frequency domain signal;
a virtual address determining module that determines a maximum energy value of the frequency domain signal, determines a virtual address according to a frequency value corresponding to the maximum energy value, and sends the virtual address to a server;
a second receiving module that receives location information of the mobile device corresponding to the virtual address from the server; and
a displaying module that displays the location information on a display device of the mobile device.

9. The mobile device according to claim 8, wherein the address signal is obtained according to one or more sine wave signals generated by the signal generator.

10. The mobile device according to claim 9, wherein the address signal is obtained using a single frequency mode, a complex frequency mode, or an enhanced mode.

11. The mobile device according to claim 8, wherein the signal transform module transforms the address signal into the frequency domain signal using a fast Fourier transform (FFT) method or a discrete cosine transform (DCT) method.

12. The mobile device according to claim 8, wherein the virtual address determining module determines the maximum energy value of the frequency domain signal by:
obtaining energy values that are greater than a preset value from the frequency domain signal;
creating a binary search tree using the obtained energy values;
searching for a maximum value in the binary search tree using a binary tree traversal method, the maximum value being determined as the maximum energy value of the frequency domain signal.

13. The mobile device according to claim 8, wherein the virtual address comprises the frequency value corresponding to the maximum energy value and preset frequency values.

14. The mobile device according to claim 8, wherein the location information of the mobile device is determined according to a preset mapping document, the preset mapping document storing a one-to-one mapping relation between a plurality of virtual addresses of the mobile device and physical location information of the mobile device.

15. A non-transitory storage medium having stored thereon instructions that, when executed by a processor of a mobile device, causes the mobile device to perform a method for determining a location of the mobile device, the method comprising:
receiving an address signal from a signal generator;
transforming the address signal into a frequency domain signal;
determining a maximum energy value of the frequency domain signal, determines a virtual address according to a frequency value corresponding to the maximum energy value, and sends the virtual address to a server;
receiving location information of the mobile device corresponding to the virtual address from the server; and
displaying the location information on a display device of the mobile device.

16. The non-transitory storage medium according to claim 15, wherein the address signal is obtained using a single frequency mode, a complex frequency mode, or an enhanced mode.

17. The non-transitory storage medium according to claim 15, wherein the address signal is transformed into the frequency domain signal using a fast Fourier transform (FFT) method or a discrete cosine transform (DCT) method.

18. The non-transitory storage medium according to claim 15, wherein the maximum energy value of the frequency domain signal is determined by:
obtaining energy values that are greater than a preset value from the frequency domain signal;
creating a binary search tree using the obtained energy values; and
searching for a maximum value in the binary search tree using a binary tree traversal method, the maximum value being determined as the maximum energy value of the frequency domain signal.

19. The non-transitory storage medium according to claim 15, wherein the virtual address comprises the frequency value corresponding to the maximum energy value and preset frequency values.

20. The non-transitory storage medium according to claim 15, wherein the location information of the mobile device are determined according to a preset mapping document, the preset mapping document storing a one-to-one mapping relation between a plurality of virtual addresses of the mobile device and physical location information of the mobile device.
